(19) United States
(12) Patent Application Publication
(10) Pub. No.: US 2019/0204151 A1
(43) Pub. Date: Jul. 4, 2019

(54) SPECTROMETER, A SPECTRUM SAMPLING DEVICE AND SPECTRUM CORRECTION METHOD

(71) Applicant: InnoSpectra Corporation, Hsinchu County (TW)

(72) Inventors: Ming-Hui Lin, Hsinchu County (TW); Cheng-Hsiung Chen, Hsinchu County (TW); He-Yi Hsieh, Hsinchu County (TW); Yung-Yu Huang, Hsinchu County (TW); Hsi-Pin Li, Hsinchu County (TW)

(73) Assignee: InnoSpectra Corporation, Hsinchu County (TW)

(21) Appl. No.: 16/231,609

(22) Filed: Dec. 24, 2018

(30) Foreign Application Priority Data
Dec. 29, 2017 (CN) 201711469582.8

(51) Int. Cl. G01J 3/28; G01J 3/10; G01J 3/02

(52) U.S. Cl. CPC G01J 3/2803; G01J 2003/2866; G01J 3/0218; G01J 3/10

(57) ABSTRACT

A spectrometer including a spectrum sampling device and a spectrometer engine is provided. The spectrum sampling device outputs an identification signal. The spectrometer engine is electrically connected to the spectrum sampling device. The spectrometer engine receives the identification signal and a spectrum. The spectrometer engine has a plurality of wavelength correction functions, and the spectrometer engine selects one of the plurality of wavelength correction functions according to the identification signal. The spectrometer engine corrects the spectrum according to the selected wavelength correction function. Moreover, a spectrum sampling device and a spectrum correction method are also provided. The spectrometer of the invention is adapted to improve accuracy of spectrum measurement.

### CROSS-REFERENCE TO RELATED APPLICATION

This application claims the priority benefit of China application serial no. 201711469582.8, filed on Dec. 29, 2017. The entirety of the above-mentioned patent application is hereby incorporated by reference herein and made a part of this specification.

### BACKGROUND OF THE INVENTION

### Field of the Invention

The invention relates to a spectrometer, a spectrum sampling device and a spectrum correction method.

### Description of Related Art

Spectrometer is widely applied to material analysis applications, and in order to ensure accuracy of a wavelength measured by the spectrometer, wavelength correction has to be performed to the spectrometer. After the wavelength correction, software of the spectrometer corresponds a measured spectrum signal intensity to a correct wavelength position according to wavelength correction parameters. Generally, the wavelength correction parameters of the spectrometer are stored in a memory circuit of spectrometer hardware.

A spectrometer engine may be matched with different sampling modules, for example, a transmissive, a reflective, or an optical fiber input module. The different sampling modules and the spectrometer engine construct the integral spectrometer. However, the wavelength accuracy of the spectrometer is influenced by the above combinations of the modules. Different sampling methods require modifying the wavelength correction parameters, so as to ensure the accuracy of the measurement.

Generally, each of the spectrometers only has one set of wavelength correction parameters, so that when the spectrometer switches the sampling modules, the spectrometer software requires modifying the wavelength correction parameters. However, it is easy to make mistakes by manually modifying the parameters. Therefore, an automatic parameter selection method of the spectrometer is required to be developed.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the invention were acknowledged by a person of ordinary skill in the art.

### SUMMARY OF THE INVENTION

The invention is directed to a spectrometer, a spectrum sampling device and a spectrum correction method, which are adapted to select one of a plurality of wavelength correction functions according to an identification signal, and correct a spectrum according to the selected wavelength correction function.

Other objects and advantages of the invention can be further illustrated by the technical features broadly embodied and described as follows.

In order to achieve one or a portion of or all of the objects or other objects, an embodiment of the invention provides a spectrum sampling device. The spectrum sampling device is electrically connected to a spectrometer engine, and the spectrum sampling device includes a sampling circuit, where the sampling circuit includes a connector circuit and a controller circuit. The connector circuit is electrically connected to the spectrometer engine, and the controller circuit is electrically connected to the connector circuit, where the sampling circuit has an identification signal, which is used by the spectrometer engine to identify the spectrum sampling device.

In order to achieve one or a portion of or all of the objects or other objects, an embodiment of the invention provides a spectrum correction method adapted to a spectrometer, where the spectrometer includes a spectrum sampling device. The spectrum correction method includes receiving an identification signal from the spectrum sampling device; selecting one of a plurality of wavelength correction functions according to the identification signal; and correcting a received spectrum according to the selected wavelength correction function. According to the above description, the embodiments of the invention have at least one of the following advantages or effects. The spectrometer engine selects the wavelength correction function according to the identification signal output by the spectrum sampling device, and corrects the spectrum according to the selected wavelength correction function.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a block diagram of a spectrometer according to an embodiment of the invention.

FIG. 1B is a block diagram of a spectrometer engine according to an embodiment of the invention.

FIG. 2 is a schematic diagram of wavelength shift according to an embodiment of the invention.

FIG. 3 is a circuit block diagram of a spectrometer according to an embodiment of the invention.

FIG. 4A, FIG. 4B and FIG. 4C are schematic diagrams illustrating a plurality of signal generation circuits according to an embodiment of the invention.

FIG. 5 is a circuit block diagram of a spectrometer according to another embodiment of the invention.

FIG. 6 is a flowchart of determining an identification signal according to an embodiment of the invention.

FIG. 7 is a flowchart of a spectrum correction method according to an embodiment of the invention.

FIG. 8A, FIG. 8B and FIG. 8C are schematic diagrams of transforming a spectrum of a relative position of a detection point pixel into a spectrum of a corresponding wavelength according to an embodiment of the invention.

FIG. 9 is a circuit block diagram of a spectrometer according to another embodiment of the invention.

### DESCRIPTION OF EMBODIMENTS

It is to be understood that other embodiment may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings.

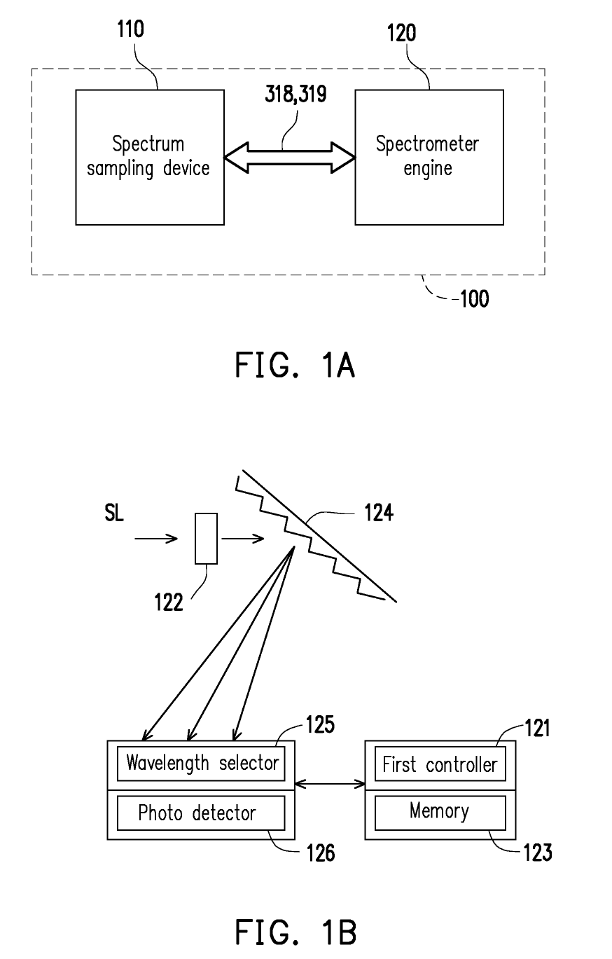

FIG. 1A is a block diagram of a spectrometer according to an embodiment of the invention. Referring to FIG. 1A, the spectrometer 100 of the present embodiment includes a spectrum sampling device 110 and a spectrometer engine 120. The spectrum sampling device 110 is electrically connected to the spectrometer engine 120. The spectrum sampling device 110 outputs an identification signal 319 and/or a sensing signal 318. The spectrometer engine 120 receives the identification signal 319 and/or the sensing signal 318. In the present embodiment, the spectrum sampling device 110 may be a transmissive spectrum sampling device, a reflective spectrum sampling device or an optical fiber input spectrum sampling device (which is also referred to as an optical fiber adapter), which is not limited by the invention. Moreover, the spectrometer engine 120 provides a power supply to the spectrum sampling device 110. The spectrum sampling device 110 and the spectrometer engine 120 transmit and receive control signals to/from each other through a common connection device such as a universal serial bus (USB), etc., though the invention is not limited thereto.

In the present embodiment, the spectrometer is, for example, a transmissive spectrometer, a reflective spectrometer, an optical fiber input spectrometer, etc. The transmissive spectrometer includes a spectrometer engine and a transmissive spectrum sampling device. The reflective spectrometer includes a spectrometer engine and a reflective spectrum sampling device. The optical fiber input spectrometer includes a spectrometer engine and an optical fiber input spectrum sampling device.

FIG. 1B is a block diagram of a spectrometer engine according to an embodiment of the invention. Referring to FIG. 1B, in the present embodiment, the spectrometer engine 120, for example, includes a first controller circuit 121, a slit module 122, a memory circuit 123, a grating device 124, a wavelength selector 125 and a photo detector 126, though the types and structures of the spectrometer engine are not limited by the invention. A light produced through a sample is a sample light SL, which is described in detail later. The sample light SL passes through the slit module 122 and is transmitted to the grating device 124, and the sample light SL is separated into a spectrum with different wavelengths through the grating device 124, and is transmitted to the wavelength selector 125 and the photo detector 126, and the first controller circuit 121 computes and analyzes a spectrum distribution represented by the sample, and stores the same to the memory circuit 123. Moreover, in another embodiment, the memory circuit 123 at least stores three sets of wavelength correction functions and corresponding identification signal characteristics, which are described in detail later.

In an embodiment, the first controller circuit 121 is, for example, a controller or a processor, a central processing unit (CPU), or other programmable general purpose or special purpose microprocessor, a digital signal processor (DSP), a programmable controller, an application specific integrated circuits (ASIC), a programmable logic device (PLD), or other similar device, or a combination of the above devices, though the invention is not limited thereto. The slit module 122 is, for example, a slit sheet, and the sample light may pass through the slit sheet and is transmitted to the grating device 124. The grating device 124 is, for example, a diffraction grating, which is used for splitting light, though the invention is not limited thereto. The memory circuit 123 is, for example, a movable random access memory (RAM), a read-only memory (ROM), a flash memory, or a similar device or a combination of the above devices. The wavelength selector 125 is, for example, a reflective or a transmissive spatial light modulator (in the present embodiment, the reflective spatial light modulator is taken as an example for description), a liquid crystal on silicon (LCOS) or a digital micro-mirror device (DMD), etc. The photo detector 126 is, for example, a single photo sensor, or a complementary metal-oxide semiconductor (CMOS), though the invention is not limited thereto.

Regardless of the optical fiber input spectrometer, the reflective spectrometer or the transmissive spectrometer, an incident light, a reflected light or a transmitted light thereof passes through the slit module 122, and the grating deice 124 separates the sample light SL into the spectrum of different wavelengths. Then the first controller circuit 121 of the spectrometer engine 120 recognizes a position of a characteristic wave peak of the spectrum, and performs a mathematical operation to a wavelength of the wave peak and a pixel position of the wave peak appeared on the wavelength selector 125 to establish a wavelength correction function f(P) to describe a relationship between the wavelength and the pixel position, for example, W=f(P)=Λ×P²+B×P+C, where A, B, C are wavelength correction parameters, W is the wavelength of the characteristic wave peak, P is a relative position of a detection point pixel. A relationship between W and P is represented by W=f(P), and the relationship is not limited to the quadratic polynomial, which may also be a cubic polynomial or other corresponding expressions, and the type of the expression of the wavelength correction function is not limited by the invention.

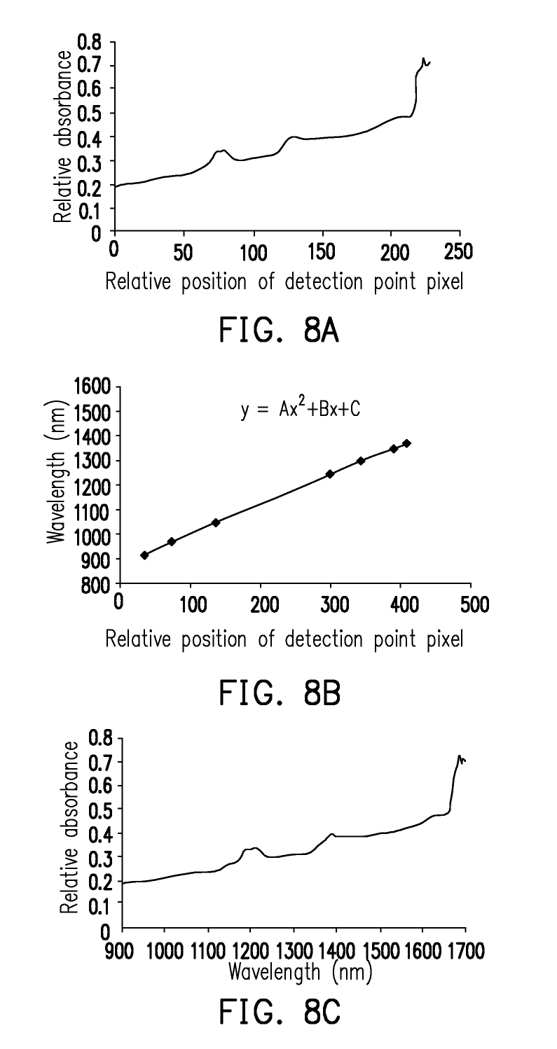

In the present embodiment, for example, A=−0.0003, B=1.3396, C=870.75, according to the wavelength correction parameters A, B, C, the first controller circuit 121 of the spectrometer engine 120 may transform the relative position of each detection point pixel into a corresponding wavelength. In this way, the first controller circuit 121 of the spectrometer engine 120 may output the spectrum of the corresponding wavelength. FIG. 8A, FIG. 8B, FIG. 8C are schematic diagrams of transforming a spectrum of the relative position of the detection point pixel into a spectrum of the corresponding wavelength according to an embodiment of the invention. FIG. 8A is a relative absorbance relationship diagram between the relative position of the detection point pixel of the wavelength selector and the spectrum. The first controller circuit 121 of the spectrometer engine 120 receives the spectrum corresponding to the sample light SL through the aforementioned method, and obtains a relationship diagram of the relative position of the detection point pixel and the wavelength, as shown in FIG. 8B, the wavelength correction function f(P) is obtained through computation. Through the wavelength correction function f(P), the first controller circuit 121 of the spectrometer engine 120 may calculate the spectrum of the corresponding wavelength, as shown in FIG. 8C. In other words, the relative absorbance relationship diagram between the relative position of the detection point pixel of the wavelength selector and the spectrum of FIG. 8A is transformed into the spectrum of the corresponding wavelength of FIG. 8C through the wavelength correction function f(P) shown in FIG. 8B.

However, although the aforementioned wavelength correction method of transforming the relative position of the detection point pixel into the corresponding wavelength is applied to any spectrum sampling method, when the spectrometer has a plurality of spectrum sampling methods, for example, the optical fiber input-based spectrometer engine added with the reflective spectrum sampling device construct the reflective spectrometer, or the optical fiber input-based spectrometer engine added with the transmissive spectrum sampling device construct the transmissive spectrometer, since an optical path and components of the added sampling device may influence the optical characteristics of the original spectrometer, an accuracy of the wavelength corresponding to the relative position of the detection point pixel has to be corrected according to different spectrum sampling methods, otherwise it is unable to ensure the wavelength accuracy of the optical fiber input, the reflective or the transmissive spectrum sampling.

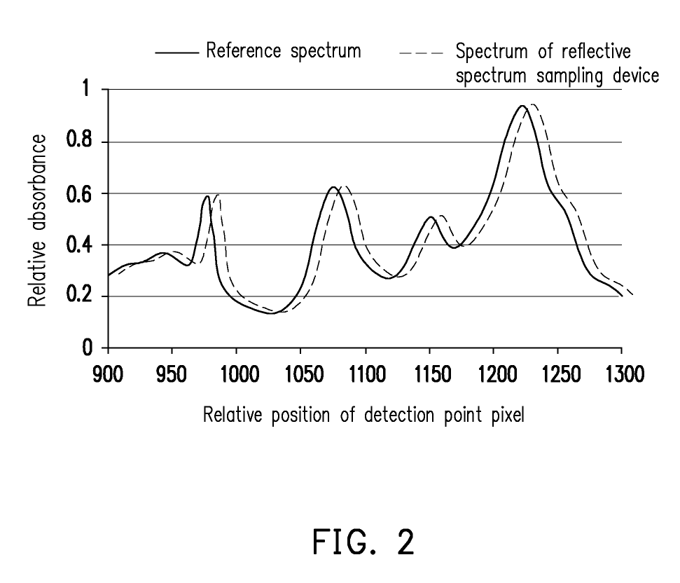

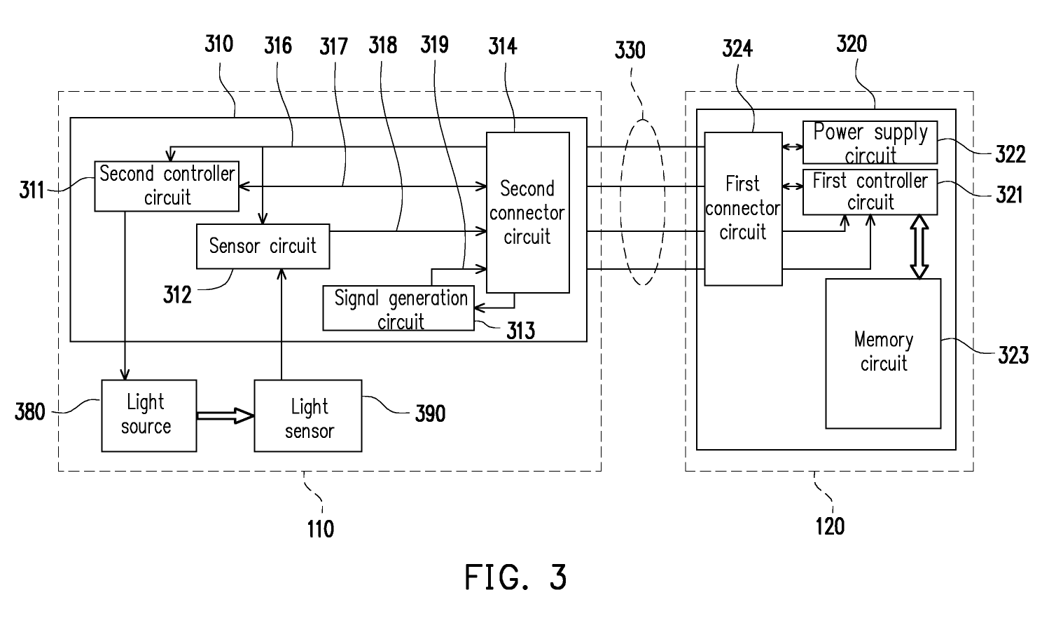

For example, FIG. 2 illustrates a situation of wavelength shift, where a horizontal axis is wavelength and a vertical axis is a relative absorbance. A solid line is a reference spectrum of standard sample, and a dotted line is a spectrum of the standard sample observed through the spectrometer having the reflective spectrum sampling device (spectrum of the reflective spectrum sampling device), and the wavelength shift is caused since the spectrometer having the reflective spectrum sampling device is not further corrected, and the wavelength correction function of the original spectrometer is directly used. Therefore, a spectrometer capable of automatically correcting the wavelength correction function for different sampling methods is required to ensure accuracy of spectrum measurement. In other words, in the present embodiment, different sampling devices have different wavelength correction parameters to obtain different wavelength correction functions.

FIG. 3 is a circuit block diagram of a spectrometer according to an embodiment of the invention. Referring to FIG. 1A and FIG. 3, the spectrum sampling device 110 of the present embodiment may include a sampling circuit 310, a light source 380 and a light sensor 390. The sampling circuit 310 is electrically connected to the light source 380 and the light sensor 390. The sampling circuit 310 is, for example, a circuit layout on a circuit board, where the circuit board is disposed in the spectrum sampling device 110. It should be noted that the circuit, sensor, etc., mentioned in the invention may be an integrated circuit chip (IC chip). The light source 380 may output an illumination light, and the light sensor 390 is used for sensing the illumination light, where the light source 380 is, for example, a light-emitting diode (LED), a sample having a self-luminous characteristic or a light source of an external environment. The illumination light provided by the light source irradiates the sample to produce a reflected light, or irradiates the sample and passes through the sample to produce a transmissive light, or a self-luminous sample produces the sample light SL. The light sensor 390 is, for example, a photo sensing diode, though the types of the light source 380 and the light sensor 390 are not limited by the invention. The sampling circuit 310 may include a second controller circuit 311, a sensor circuit 312, a signal generation circuit 313 and a second connector circuit 314. The second controller circuit 311 is, for example, a controller or a processor, and the processor is, for example, a central processing unit (CPU), or other programmable general purpose or special purpose microprocessor, a digital signal processor (DSP), a programmable controller, an application specific integrated circuits (ASIC), a programmable logic device (PLD), or other similar device, or a combination of the above devices. Moreover, the second controller circuit 311 is electrically connected to the second connector circuit 314, and the second controller circuit 311 receives a power signal 316 provided by the spectrometer engine 120, and the second controller circuit 311 supplies power to the light source 380 to output the illumination light. The above power signal 316 refers to electric power (for example, a current or a voltage). Through the second connector circuit 314, the spectrometer engine 120 communicates with the second controller circuit 311 through a control signal 317, for example, to drive the second controller circuit 311 to operate.

In the present embodiment, in FIG. 3, the sensor circuit 312 is electrically connected to the second connector circuit 314, and receives a conversion signal form the light sensor 390, and performs signal processing (such as signal noise removal or signal reduction and amplification) to the conversion signal to output a sensing signal 318, and the sensor circuit 312 is electrically connected to a first connector circuit 324 of the spectrometer engine 120 through the second connector circuit 314 and connection lines 330 for transmitting the sensing signal 318 to a first controller circuit 321. The first controller circuit 321 determines whether an intensity (brightness) of the illumination light emitted by the light source 380 is complied with a predetermined value stored in a memory circuit 323 of the spectrometer engine 120 according to the sensing signal 318, and a reason thereof is that the illumination light emitted by the light source 380 of each spectrum sampling device 110 does not have the same intensity. In the present embodiment, when the first controller circuit 321 determines that the intensity of the illumination light emitted by the light source 380 is not complied with the predetermined value stored in the memory circuit 323 of the spectrometer engine 120, the first controller circuit 321 may control the second controller circuit 311 through the control signal 317, so as to adjust the intensity of the illumination light emitted by the light source 380. Moreover, the sensor circuit 312 receives the power signal 316 from the first connector circuit 324 through the connection lines and the second connector circuit 314.

In the present embodiment, the second connector circuit 314 of the spectrum sampling device 110 is connected to the first connector circuit 324 of the spectrometer engine 120 through the connection lines 330, and outputs an identification signal 319 and the sensing signal 318 to the first connector circuit 324, and receives the power signal 316 from the first connector circuit 324. In the present embodiment, the connection lines 330 may be a common connection device, for example, a USB, etc., though the invention is not limited thereto.

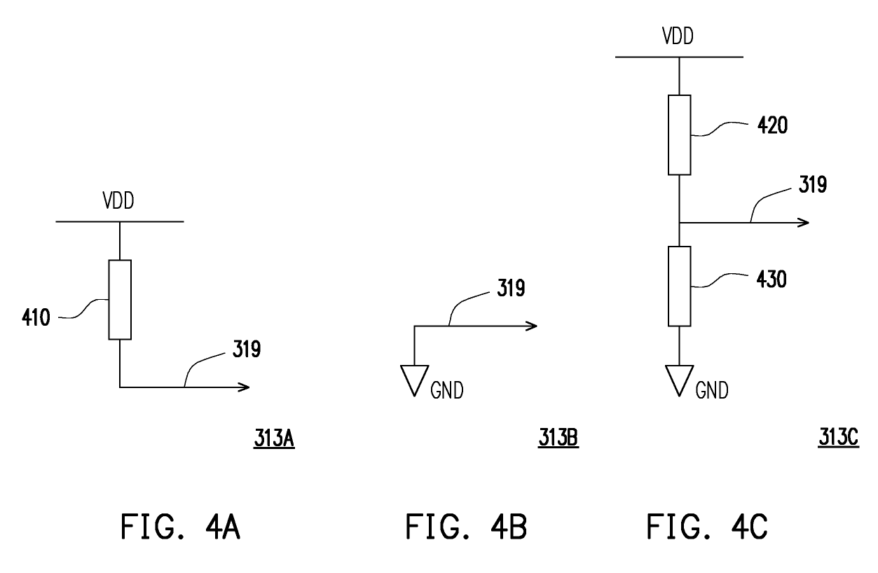

Referring to FIG. 3, FIG. 4A, FIG. 4B and FIG. 4C, the signal generation circuit 313 is electrically connected to the second connector circuit 314, and outputs the identification signal 319 to the spectrometer engine 120 through the second connector circuit 314. FIG. 4A, FIG. 4B and FIG. 4C are schematic diagrams illustrating signal generation circuits 313A, 313B and 313C. In the present embodiment, one of the signal generation circuits 313A, 313B, 313C illustrated in FIG. 4A, FIG. 4B and FIG. 4C may be used to generate the identification signal 319, which is well known by those with ordinary skills in the art. In FIG. 4A, the signal generation circuit 313A generates the identification signal 319 through a power voltage VDD (for example, the power signal 316) provided by the spectrometer engine 120 and a resistor 410. In FIG. 4B, the signal generation circuit 313B generates the identification signal 319 through a voltage difference of a ground voltage GND. In FIG. 4C, the identification signal 319 is generated through the power voltage VDD provided by the spectrometer engine 120, the ground voltage GND, a resistor 420 and a resistor 430 in a voltage dividing manner. In the present embodiment, the identification signal 319 generated by the signal generation circuit 313 may be a simple voltage difference value, or the identification signal 319 is a signal transformed from an analog signal to a digital signal, which are all within a protection scope of the invention. The signal generation circuit 313 may also generate the identification signal 319 through other methods, and the circuit structure of the signal generation circuit 313 is not limited by the invention.

Referring to FIG. 3, the spectrometer engine 120 includes a spectrometer engine circuit board 320. The spectrometer engine circuit board 320 may include the first connector circuit 324, a power supply circuit 322, the first controller circuit 321 and the memory circuit 323. The type and structure of the spectrometer engine 120 is not limited by the invention. In the present embodiment, the first connector circuit 324 is electrically connected to the second connector circuit 314 in the sampling circuit 310 through the connection lines 330. Moreover, the first connector circuit 324 receives the identification signal 319 and the sensing signal 318 from the sampling circuit 310. The power supply circuit 322 provides the power signal 316 to the sampling circuit 310 through the first connector circuit 324. The first controller circuit 321 is electrically connected to the first connector circuit 324. The first controller circuit 321 receives the identification signal 319 and the sensing signal 318 through the first connector circuit 324. The memory circuit 323 is electrically connected to the first controller circuit 321. At least three sets of wavelength correction functions (in other words, three sets of wavelength correction parameters) and the corresponding identification signal characteristics are stored in the memory circuit 323 to respectively correspond to at least three types of spectrum sampling devices including the transmissive spectrum sampling device, the reflective spectrum sampling device and the optical fiber input spectrum sampling device.

In the present embodiment, the first controller circuit 321 compares the identification signal 319 receives from the spectrum sampling device 110 to determine whether the identification signal 319 is complied with one of a plurality of identification signal characteristics pre-stored in the memory circuit 323, and the first controller circuit 321 automatically determines the type of the spectrum sampling device 110 electrically connected to the spectrometer engine 120, for example, one of the transmissive spectrum sampling device, the reflective spectrum sampling device and the optical fiber input spectrum sampling device, and automatically selects the corresponding wavelength correction function, so as to correct the spectrum received by the first controller circuit of the spectrometer engine according to the selected wavelength correction function. In detail, the spectrum of the sample light SL received by the first controller circuit is corrected through the selected wavelength correction function, so as to obtain the spectrum with the accurate wavelength.

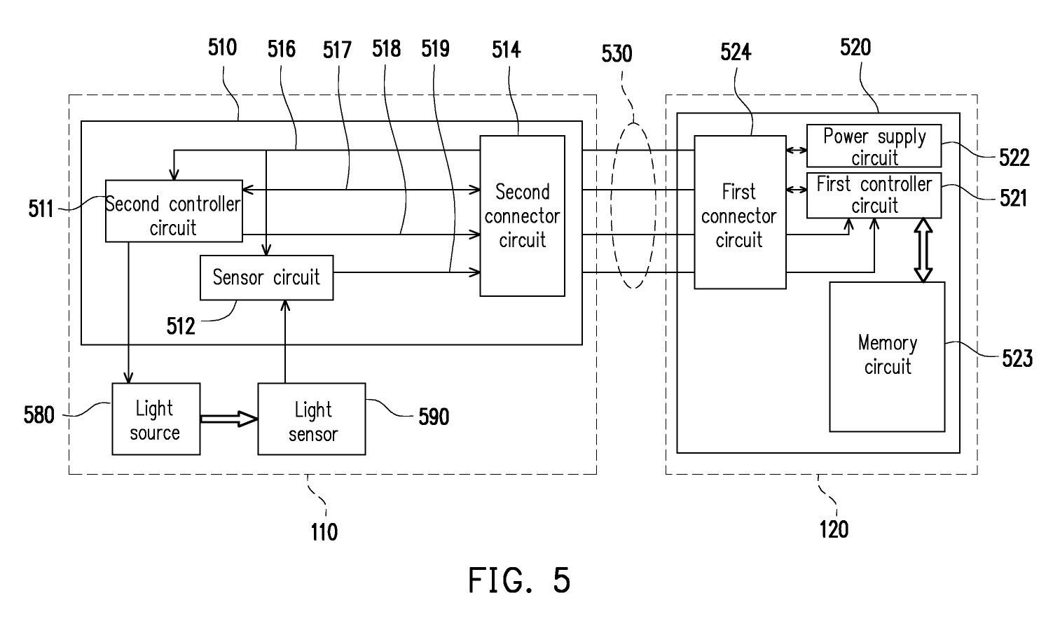

FIG. 5 is a circuit block diagram of a spectrometer according to another embodiment of the invention. A difference between the embodiments of FIG. 3 and FIG. 5 lies in different methods for generating the identification signal. In FIG. 3, the identification signal 319 is generated by the signal generation circuit 313. In FIG. 5, the identification signal 518 is generated by a second controller circuit 511, and in another embodiment, the identification signal 518 may be stored in the second controller circuit 511, where the second controller circuit 511 may have a memory circuit to store the identification signal 518.

As shown in FIG. 5, the light source 580 may output an illumination light, and the light sensor 590 is used for sensing the illumination light, and the types of the light source 580 and the light sensor 590 are not limited by the invention. The sampling circuit 510 may include the second controller circuit 511, a sensor circuit 512 and a second connector circuit 514. The second controller circuit 511 is electrically connected to the second connector circuit 514, and the second controller circuit 511 receives a power signal 516 provided by the spectrometer engine 120. The second controller circuit 511 supplies power to the light source 580 to output the illumination light, and controls the light source 580 to output light.

The spectrometer engine 120 communicates with the second controller circuit 511 through a control signal 517 via the second connector circuit 514, for example, to drive the second controller circuit 511 to operate. The second controller circuit 511 performs signal transmission with the spectrometer engine 120 through the second connector circuit 514, and outputs the identification signal 518 to the spectrometer engine 120. The method of generating the identification signal 518 by the second controller circuit 511 is not limited by the invention, and the identification circuit 518 is, for example, a predetermined value or an ID number, which is used for representing the spectrum sampling device 110. The sensor circuit 512 is electrically connected to the second connector circuit 514. The sensor circuit 512 receives a transform signal coming from the light sensor 590, and outputs a processed sensing signal 519. The second connector circuit 514 is electrically connected to the first connector circuit 524 through the connection lines 530. The second connector circuit 514 outputs the identification signal 518 and the sensing signal 519 to the first connector circuit 524. The second connector circuit 514 receives the power signal 516 from the first connector circuit 524.

Referring to FIG. 5, the spectrometer engine 120 includes a spectrometer engine circuit board 520. The spectrometer engine circuit board 520 may include the first connector circuit 524, a power supply circuit 522, the first controller circuit 521 and a memory circuit 523. The electrical connection method thereof and the operation methods thereof are the same to that of FIG. 3, and detail thereof is not repeated. In the present embodiment, the first controller circuit 521 of the spectrometer engine circuit board 520 compares the identification signal 518 receives from the spectrum sampling device 110 to determine whether the identification signal 518 is complied with one of a plurality of identification signal characteristics pre-stored in the memory circuit 523, and the first controller circuit 521 automatically determines the type of the spectrum sampling device 110 electrically connected to the spectrometer engine 120, for example, one of the transmissive spectrum sampling device, the reflective spectrum sampling device and the optical fiber input spectrum sampling device, and automatically selects the corresponding wavelength correction function, so as to correct the spectrum received by the first controller circuit 521 of the spectrometer engine according to the selected wavelength correction function.

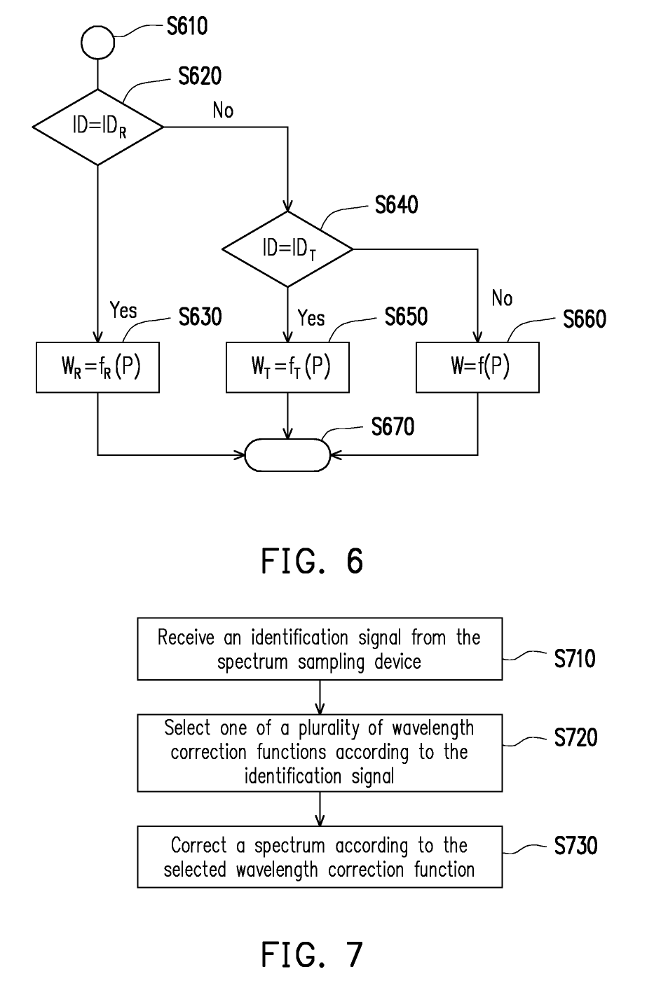

FIG. 6 is a flowchart of determining the identification signal according to an embodiment of the invention. Referring to FIG. 3 and FIG. 6, in the present embodiment, the first controller circuit 321 of the spectrometer engine 120 may determine the type of the spectrum sampling device 110 electrically connected to the spectrometer engine 120 according to the identification signal 319. For example, the ID represents the identification signal 319, ID_{R} is an identification signal of the reflective spectrum sampling device, and ID_{T} is an identification signal of the transmissive spectrum sampling device. In step S610, the spectrum sampling device 110 is coupled to the spectrometer engine 120. In step S620, the first controller circuit 321 determines whether the reflective spectrum sampling device is connected to the spectrometer engine 120, i.e. determines whether the identification signal ID is the identification signal ID_{R} of the reflective spectrum sampling device, and if it is determined that ID=ID_{R}, it represents that the reflective spectrum sampling device is connected, and a step S630 is executed, by which the first controller circuit 321 applies a wavelength correction function W_{R}=f_{R}(P) of the reflective spectrum sampling device stored in the memory circuit 323. If it is determined that ID is not equal to ID_{R}, a step S640 is executed to determine whether the transmissive spectrum sampling device is connected, i.e. to determine whether the identification signal ID is the identification signal ID_{T} of the transmissive spectrum sampling device. If it is determined that ID=ID_{T}, it represents that the transmissive spectrum sampling device is connected, and a step S650 is executed, by which a wavelength correction function W_{T}=f_{T}(P) of the transmissive spectrum sampling device stored in the memory circuit 323 is applied. If it is determined that ID is not equal to ID_{T}, it represents that the identification signal read by the spectrometer engine 120 is neither the reflective identification signal ID_{R} nor the transmissive identification signal ID_{T}, and it is determined that the optical fiber input spectrum sampling device is connected, and now a wavelength correction function W=f(P) of the optical fiber input spectrum sampling device stored in the memory circuit 323 is applied, as shown in step S660. In step S670, after the wavelength correction function is selected, the spectrum received by the first controller circuit 321 is corrected according to the selected wavelength correction function.

It should be noted that the above steps are only an example, and the wavelength correction function W=f(P) of the optical fiber input spectrum sampling device is set as a predetermined value. In other embodiments, in the step S620, the first controller circuit 321 first determines whether the transmissive spectrum sampling device is connected to the spectrometer engine 120. In the step S640, it is determined whether the reflective spectrum sampling device is connected to the spectrometer engine 120. Therefore, the priority of determining different types of the sampling device connected to the spectrometer engine 120 may be determined according to manufacturer's arrangement, which is not limited by the invention. Moreover, enough instructions, recommendations and implementation description for the spectrum correction method of the invention may be learned from the descriptions of the embodiments of FIG. 1A to FIG. 5, and detail thereof is not repeated.

FIG. 7 is a flowchart of a spectrum correction method according to an embodiment of the invention. Referring to FIG. 7, in step S710, the spectrometer engine 120 receives the identification signal 319 from the spectrum sampling device 110. Then, in step S720, the identification signal 319 is compared with a plurality of identification signal characteristics pre-stored in the memory circuit 323 to determine whether the spectrum sampling device 110 is the transmissive spectrum sampling device, the reflective spectrum sampling device or the optical fiber input spectrum sampling device, and a corresponding wavelength correction function is selected according to determination result of the identification signal 319. In step S730, spectrum correction is performed according to the selected wavelength correction function, such that in the spectrometer 100, regardless of which type of the spectrum sampling device 110 that the spectrometer engine 120 is connected to, the correct correction parameters may all be automatically applied to the wavelength correction function to resolve the problem of wavelength shift.

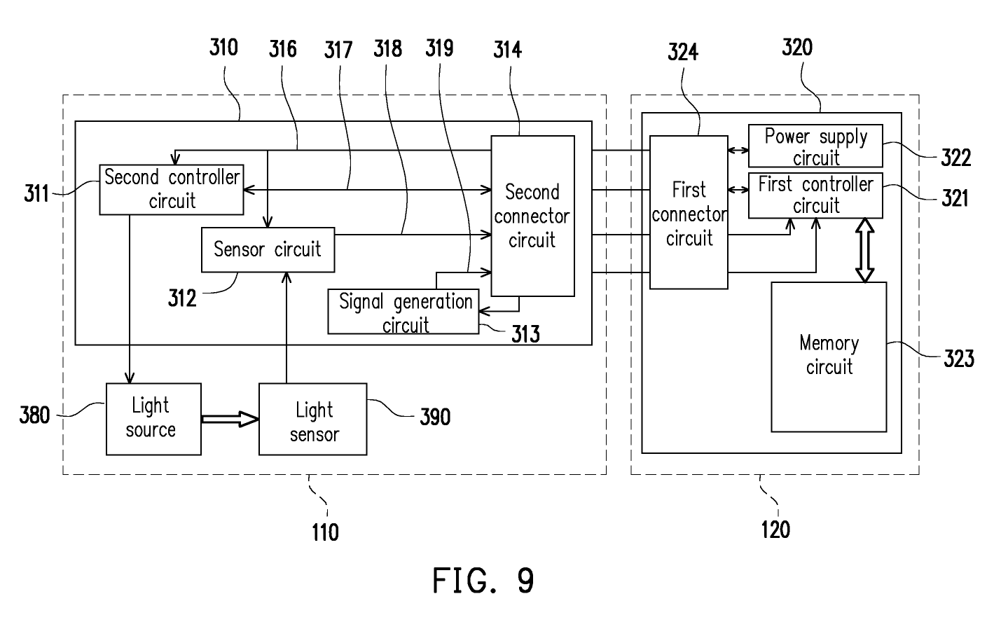

FIG. 9 is a circuit block diagram of a spectrometer according to another embodiment of the invention. Referring to FIG. 3 and FIG. 9, a difference between the two embodiments of the invention is that in the embodiment of FIG. 9, the connection lines 330 are not used, and the first connector circuit 324 and the second connector circuit 314, for example, respectively have metal terminals (for example, golden fingers), and the metal terminals may be directly connected to transmit power and signals there between.

In summary, the embodiments of the invention at least have one of the following advantages or effects. In the exemplary embodiments of the invention, the spectrometer engine determines the type of the connected spectrum sampling device according to the identification signal output by the sampling circuit, and selects the corresponding correction parameters for correcting the received spectrum through the first controller circuit of the spectrometer engine, so as to achieve the accurate measurement effect of the spectrometer.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents. Moreover, any embodiment of or the claims of the invention is unnecessary to implement all advantages or features disclosed by the invention. Moreover, the abstract and the name of the invention are only used to assist patent searching. Moreover, “first”, “second”, etc. mentioned in the specification and the claims are merely used to name the elements and should not be regarded as limiting the upper or lower bound of the number of the components/devices.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A spectrometer, comprising:
a spectrum sampling device, configured to output an identification signal; and
an spectrometer engine, electrically connected to the spectrum sampling device, and configured to receive the identification signal and receive a spectrum,
wherein the spectrometer engine comprises a plurality of wavelength correction functions, and the spectrometer engine selects one of the plurality of wavelength correction functions according to the identification signal, and corrects the spectrum according to the selected wavelength correction function.

2. The spectrometer as claimed in claim 1, wherein the spectrometer engine comprises:
a first connector circuit, electrically connected to the spectrum sampling device, and configured to receive the identification signal and a sensing signal from the spectrum sampling device;
a power supply circuit, configured to output a power signal to the spectrum sampling device through the first connector circuit;
a first controller circuit, electrically connected to the first connector circuit, and configured to receive the identification signal from the first connector circuit; and
a memory circuit, electrically connected to the first controller circuit, and configured to store the plurality of wavelength correction functions.

3. The spectrometer as claimed in claim 2, wherein the spectrum sampling device comprises:
a light source, configured to output an illumination light;
a light sensor, configured to sense the illumination light and generate a transform signal; and
a sampling circuit, electrically connected to the light source and the light sensor, and configured to control the light source to output the illumination light and receive the transform signal coming from the light sensor,
wherein the sampling circuit outputs the identification signal to the first connector circuit of the spectrometer engine, and the first controller circuit of the spectrometer engine selects one of the plurality of wavelength correction functions according to the identification signal.

4. The spectrometer as claimed in claim 3, wherein the light source is a self-luminous sample or a light source of an external environment.

5. The spectrometer as claimed in claim 3, wherein the sampling circuit comprises:
a second connector circuit, electrically connected to the first connector circuit of the spectrometer engine, outputting the identification signal to the first connector circuit, and receiving the power signal from the first connector circuit;
a second controller circuit, electrically connected to the second connector circuit, receiving the power signal, and controlling the light source to output the illumination light; and
a sensor circuit, electrically connected to the second connector circuit, and receiving the power signal and the transform signal coming from the light sensor, wherein the sensor circuit transforms the transform signal into a sensing signal, and outputs the sensing signal to the first connector circuit.

6. The spectrometer as claimed in claim 5, wherein the sampling circuit comprises:
a signal generation circuit, electrically connected to the second connector circuit, configured to generate the identification signal according to the power signal and/or a ground signal, and outputting the identification signal to the spectrometer engine through the second connector circuit.

7. The spectrometer as claimed in claim 5, wherein the second controller circuit is configured to generate or store the identification signal, and outputs the identification signal to the spectrometer engine through the second connector circuit.

8. The spectrometer as claimed in claim 1, wherein the spectrum sampling device is one of an optical fiber input spectrum sampling device, a reflective spectrum sampling device and a transmissive spectrum sampling device.

9. The spectrometer as claimed in claim 1, wherein the spectrometer engine further comprises a slit module, a grating device, a wavelength selector and a photo detector, wherein a sample light coming from a sample passes through the slit module and is transmitted to the grating device, and the sample light is separated into the spectrum with different wavelengths through the grating device, and is transmitted to the wavelength selector and the photo detector, and the first controller circuit computes and analyzes a distribution of the spectrum represented by the sample, and stores the same to a memory circuit.

10. The spectrometer as claimed in claim 1, wherein the wavelength selector is a digital micro-mirror device (DMD) or a liquid crystal on silicon (LCOS).

11. A spectrum sampling device, electrically connected to a spectrometer engine, and the spectrum sampling device comprising:
a sampling circuit, comprising:
a connector circuit, electrically connected to the spectrometer engine; and
a controller circuit, electrically connected to the connector circuit, wherein the sampling circuit comprises an identification signal adapted to be used by the spectrometer engine to identify the spectrum sampling device.

12. The spectrum sampling device as claimed in claim 11, wherein the connector circuit and the controller circuit receive a power signal provided by the spectrometer engine.

13. The spectrum sampling device as claimed in claim 12, wherein the sampling circuit further comprises a signal generation circuit, the signal generation circuit is electrically connected to the connector circuit, and configured to generate the identification signal according to the power signal and/or a ground signal, and outputs the identification signal to the spectrometer engine through the connector circuit.

14. The spectrum sampling device as claimed in claim 11, wherein the controller circuit is configured to generate or store the identification signal, and outputs the identification signal to the spectrometer engine through the connector circuit.

15. The spectrum sampling device as claimed in claim 11, wherein the sampling circuit outputs the identification signal to the spectrometer engine, and the spectrometer engine selects one of a plurality of wavelength correction functions according to the identification signal, and the plurality of wavelength correction functions is stored in the spectrometer engine.

16. The spectrum sampling device as claimed in claim 11, further comprising:
a light source, configured to output an illumination light; and
a light sensor, configured to sense the illumination light, and generating a transform signal, wherein the sampling circuit is electrically connected to the light source and the light sensor, and configured to control the light source to output the illumination light and receive the transform signal coming from the light sensor.

17. The spectrum sampling device as claimed in claim 16, wherein the sampling circuit further comprises a sensor circuit, the sensor circuit is electrically connected to the connector circuit, receives the transform signal coming from the light sensor, and transforms the transform signal into a sensing signal, and outputs the sensing signal to the connector circuit.

18. The spectrum sampling device as claimed in claim 16, wherein the light source is a self-luminous sample or a light source of an external environment.

19. A spectrum correction method, adapted to a spectrometer, wherein the spectrometer comprises a spectrum sampling device, the spectrum correction method comprising:
receiving an identification signal from the spectrum sampling device;
selecting one of a plurality of wavelength correction functions according to the identification signal; and
correcting a received spectrum according to the selected wavelength correction function.

20. The spectrum correction method as claimed in claim 19, further comprising: outputting a power signal to the spectrum sampling device, wherein the spectrum sampling device generates the identification signal according to the power signal and/or a ground signal.

21. The spectrum correction method as claimed in claim 19, further comprising: storing the plurality of wavelength correction functions.

22. The spectrum correction method as claimed in claim 19, wherein the spectrum sampling device is one of an optical fiber input spectrum sampling device, a reflective spectrum sampling device and a transmissive spectrum sampling device.
